(19) United States
(12) Patent Application Publication
(10) Pub. No.: US 2022/0389156 A1
(43) Pub. Date: Dec. 8, 2022

(54) HIGH DENSITY POLYESTER PRODUCT, COMPOSITION AND USE

(71) Applicant: EQUUS UK TOPCO LTD, Goole, East Yorkshire (GB)

(72) Inventors: Kevin John Duncan, Goole, East Yorkshire (GB); Ben Cale, Goole, East Yorkshire (GB)

(73) Assignee: EQUUS UK TOPCO LTD, Goole, East Yorkshire (GB)

(21) Appl. No.: 17/770,485

(22) PCT Filed: Oct. 22, 2020
(86) PCT No.: PCT/EP2020/079687

§ 371 Date: Apr. 20, 2022

(30) Foreign Application Priority Data
Oct. 23, 2019 (GB) 1915316.2

(51) Int. Cl. C08G 63/672; C10M 107/32

(52) U.S. Cl. CPC C08G 63/672; C10M 107/32; C10M 2207/283; C10M 2209/1023; C10N 2020/017

(57) ABSTRACT

The present invention relates to a polyester product having a relatively high atypical density of greater than 1 g/cm³ at 25° C., the polyester product comprises the reaction product of one or more C2 to C12 polybasic acid and one or more polyol. The invention also relates to methods of making the polyester product, compositions containing or comprising the polyester product and the use of such compositions. More especially, the polyester containing compositions may advantageously be utilised in aqueous environment applications, or other applications, where environmental containment is an important consideration.

The present invention relates to a polyester product having a relatively high density, a composition comprising said polyester and the uses of such polyester containing compositions. The invention also relates to methods of making the polyester product. More especially, the polyester containing compositions may advantageously be utilised in aqueous environment applications, or other applications, where environmental containment is an important consideration.

In general terms, polyesters are polymers formed from the reaction of acids and alcohols typically, although not exclusively, via esterification in the presence of a catalyst. A huge range of different polyester products are known, and their suitability for a wide variety of application areas is appreciated. The physical properties of the polyester product will dictate the application area in which the product finds utility. Use of solid polyesters in plastics for clothing and food and beverage packaging are well known and common. Fluid polyesters are known to find utility in alternative application areas such as lubricants; the present invention concerns such a fluid polyester suitable for use as a lubricant, including use as a hydraulic fluid, amongst other applications.

Although polyesters suitable for use as lubricants are known, such polyesters may have physical properties which are undesirable for some application areas, and more especially are undesirable for use in particular environments. An area of particular difficulty is use of polyester based lubricants in an aquatic environment as requisite biodegradability and toxicology profiles have proven elusive.

Another problem encountered with the use of lubricants (of any sort) in an aquatic environment is one of product containment or risk of accidental loss. For example, when a piece of equipment used underwater is damaged lubricant may rapidly leak into the aquatic environment, where the lubricant may then be problematic for remedial removal or prove toxic for aquatic life.

The present invention seeks to provide an improved polyester product which may find utility in a lubricant composition, so that the problems associated with hitherto known lubricants can be overcome, especially for use in an aqueous environment.

Accordingly, the present invention provides a polyester product comprising the reaction product of:
a) one or more C2 to C12 polybasic acid, and
b) one or more polyol;

and wherein the polyester product has a density of greater than 1 g/cm³ at 25° C.

The present invention also provides a method of making a polyester product having a density of 1 g/cm³, the method comprising reacting said a) one or more C2 to C12 polybasic acid and b) one or more polyol.

In an alternative embodiment, the present invention provides a composition comprising said polyester product.

Furthermore, the present invention provides for the use of a composition comprising said polyester product as a lubricant in an aqueous environment.

It will be understood that any upper or lower quantity or range limit stated herein may be independently combined.

It will be understood by the skilled person that, when describing the number of carbon atoms in a substituent group (e.g. ‘C1 to C6’), the number refers to the total number of carbon atoms present in the substituent group, including any present in any branched groups. Additionally, when describing the number of carbon atoms in, for example dicarboxylic acids, this refers to the total number of carbon atoms including the one at the carboxylic acid group, and any present in any branch groups.

The term ‘polyol’ is well known in the art and refers to a molecule comprising more than one hydroxyl group.

The term “polybasic acid” is well known in the art and refers to a molecule comprising more than one acid group.

The term ‘polyester’ as used herein refers to a molecule or group containing more than one ester bond.

The term ‘functionality’ as used herein with regard to a molecule or part of a molecule refers to the number of functional groups in that molecule or part of a molecule. A ‘functional group’ refers to a group in a molecule which may take part in a chemical reaction. For example, a carboxylic acid group, a hydroxyl group and an amine group are all examples of functional groups. For example, a diacid (with two carboxylic acid groups) and a diol (with two hydroxyl groups) both have a functionality of 2 and a triacid and a triol both have a functionality of 3.

The polyester product of the present invention comprises the reaction product of:
a) one or more C2 to C12 polybasic acid, and
b) one or more polyol;

and wherein the polyester product has a density of greater than 1 g/cm³ at 25° C.

Density is a measure of a materials mass (expressed here in grams) per unit volume (expressed here in centimetres). The ASTM D4052 standard test procedure provides a suitable method for measuring the density of the present polyester products.

The polyester product of the present invention has a density of greater than 1 g/cm³, preferably greater than 1.01 g/cm³, more preferably greater than 1.03 g/cm³, more preferably greater than 1.04 g/cm³, more preferably greater than 1.05 g/cm³, and most preferably a density equal to or greater than 1.06 g/cm³ at 25° C. The polyester product of the present invention has a relatively high density, which renders the polyester product particularly suitable to use in some application areas, as will be more fully described below.

The polyester product of the present invention has a density at 4° C. of greater than 1 g/cm³, preferably greater than 1.04 g/cm³, more preferably greater than 1.06 g/cm³, more preferably greater than 1.08 g/cm³, more preferably greater than 1.1 g/cm³, and most preferably a density equal to or greater than 1.15 g/cm³ at 4° C. The polyester product of the present invention has a relatively high density at 4° C., which renders the polyester product particularly suitable to use in subsea application areas, as will be more fully described below

Additionally, it is a particular advantage of the present invention that the relative high density of the polyester product is achieved without an associated increases in viscosity which would render the product difficult to handle and, for example, difficult to pump or transport when in use. Kinematic viscosity of the present materials may be calculated by following standard test method ASTM D7042. In particular the kinematic viscosity of the present polyester product at 40° C. is up to 10000 mm²/s, preferably between 2 and 5000 mm²/s, preferably between 3 and 2500 mm²/s, more preferably between 4 and 1000 mm²/s, even more preferably between 5 and 100 mm²/s, and most preferably between 40 and 75 mm²/s. The combination of such relatively low viscosity and high density properties allows the polyester product to be particularly suitable for use in subsea applications, in particular, in subsea hydraulic fluid applications where the combination of these two properties allow the product to provide an accurate response over long distances, typically via long lengths of flexible tubing or hose. For use in subsea environments the suitability of the material is also dependent upon the kinematic viscosity of the product at 4° C., many materials are known to have a viscosity which is so high at these low temperatures that the materials cannot be used. As such, it is a particular advantage that the kinematic viscosity of the present polyester product at 4° C. is no greater than 100000 mm²/s, preferably between 50 and 100000 mm²/s, more preferably between 100 and 10000 mm²/s, even more preferably between 200 and 1000 mm²/s, and most preferably between 300 and 800 mm²/s.

Optionally, and preferably, the polyester product may also comprise:
c) an end-cap.

Preferably, the end cap may be selected from one or more of the following: mono-basic acids, mono-alcohols, and epoxides. Such an end cap may be utilised to reduce the amount residual content of unreacted hydroxyl or carboxylic groups in the resulting polyester. This reduction in residual reactive species can be advantageous in improving the stability and longevity of the polyester product. Particularly advantageous is a reduction in free acid functionality provided by utilisation of an end cap, as free acidity in the polyester product can negatively affect both hydrolytic and oxidative stability; such an advantage is particularly useful in subsea applications where incidence of removal and replacement of the product will be mitigated.

Preferably, the end cap selected is a mono-alcohol or a mono-basic acid. In this case, without wishing to be bound by theory, it is believed that selection of such an end cap allows for control in the physical properties of the polyester. More especially, the use of such an appropriately selected end cap aids in control and tailoring of the viscosity of the polyester product.

In one particularly preferred embodiment the end-cap selected is a mono-basic acid or mono-alcohol, and the end cap may is equivalent to the polyol or polybasic acid present in the polyester product in terms of carbon chain length; this may allow a high degree of predictability and reproducibility in terms of the physical properties of the final polyester product.

A suitable mono-basic acids may a be linear, branched, cyclic, unsaturated, aromatic, or saturate. Preferably, the mono-basic acid is linear. Preferably the mono-basic acid is saturated. Preferably, the mono-basic acid is a C2 to C12 mono-basic acid. Examples of suitable mono-basic acids include, for example, acetic acid, acrylic acid, 2-ethylhexanoic acid, benzoic acid, 3,4,5-Trimethoxybenzoic acid, 2-(2-Methoxyethoxy)acetic acid and 2-[2-(2-Methoxyethoxy)ethoxy]acetic acid, amongst others.

More preferably, the end cap selected is a mono-alcohol. Suitable mono-alcohols include methanol, ethanol, isopropanol, 2-ethylhexanol, cyclohexanol, benzyl alcohol and glycol ethers. It is particularly preferred that the mono-alcohol is a glycol ether. The glycol ether may suitably be a small molecule which consist of between C3 and C20 in its structure, preferably between C3 and C14, more preferably between C3 and 010, more preferable between C5 and C8, and more preferably may consist of C7 or C8 in its structure. However, most preferably the glycol ether is a poly(propylene glycol) alkyl ether due to the advantageously lower volatility of such materials compared to alternative commercially available glycol ethers. Examples of suitable glycol ethers include, ethylene glycol monomethyl ether, ethylene glycol monoethyl ether, ethylene glycol monoisopropyl ether, ethylene glycol monopropyl ether, propylene glycol methyl ether, diethylene glycol monomethyl ether, diethylene glycol monoethyl ether, ethylene glycol monobutyl ether, di(propylene glycol) methyl ether, diethylene glycol butyl ether, tri(propylene glycol) methyl ether. Di(propylene glycol) methyl ether is particularly preferred as the mono-alcohol end cap. Such glycol ether materials have good biodegradability profiles rendering them especially suitable in the present polyester product when intended for use in an aqueous environment.

Additionally, or alternatively, the end cap selected is an epoxide, and in this case, it is preferable that the epoxide is a mono epoxy ester or ether. Such materials are particularly compatible with the polyester products comprising the reaction products of a) and b). Where more than one c) end cap is selected it is preferred that these are independently selected from the mono-basic acids, mono-alcohols, and epoxides, and that preferably one epoxide and one mono-basic acid or mono-alcohol is selected.

The molecular ratio of a):b):c) in the polyester product may suitably be in the range 0.1 to 1:0.1 to 1:0 to 1, preferably in the range to 0.1 to 0.8:0.1 to 0.5:0.1 to 0.2, more preferably in the range 0.1 to 0.4:0.1 to 0.4:0.15 to 0.18 and most preferably 0.2:0.12:0.16. As stated above, the presence of the c) end cap is optional, but preferred.

The,
a) one or more C2 to C12 polybasic acid,

of the polyester product will now be described in more detail.

Suitably, the one or more C2 to C12 polybasic acid may a be linear, branched, cyclic, unsaturated, aromatic, or saturated. Such polybasic acids include, for example, oxalic acid, malonic acid, succinic acid, maleic acid, fumaric acid, malic acid, tartaric acid, glutaric acid, adipic acid, pimelic acid, citric acid, trimellitic acid, suberic acid, 2,5-furandicarboxylic acid, phthalic acid, isophthalic acid, terephthalic acid, butane tetracarboxylic acid, azelaic acid, sebacic acid, dodecanedioic acid, heptane dicarboxylic acid, octenyl succinic acid, itaconic acid, 2,6 naphthalene dicarboxylic acid, esters thereof, and anhydrides thereof, for example, dimethyl adipate, propionic anhydride and succinic anhydride amongst others. In addition, carboxylic functionalised glycols may also be suitable.

Preferably the one or more C2 to C12 polybasic acid is linear. Preferably the C2 to C12 polybasic acid is saturated.

Preferably, the polyester product comprises one or more C2 to C12 polybasic acid, and more preferably the polybasic acid is a diacid or triacid, and most preferably the polybasic acid is a diacid. Dicarboxylic acids may be particularly preferred in some embodiments.

Preferably the one or more C2 to C12 polybasic acid is a C4 to C8 polybasic acid, and most preferable a C6 polybasic acid, as such adipic acid (including related ester and/or anhydride forms) may provide a particularly preferred polybasic acid. It will be appreciated that such polybasic acids are relatively short chain and low molecular weight materials, and the selection of such a material is believed to contribute to the high density of the polyester product formed from the reaction product of a) and b).

The,
b) one or more polyol,

of the polyester product will now be described in more detail.

Preferably the one or more polyol may be a diol, triol, tetrol, pentol or hexol or a mixture there of. Preferably the one or more polyol is a diol, triol or hexol, and more preferably a diol or triol. Most preferably, the one or more polyol selected is a diol.

In some particularly preferred embodiments, the one or more polyol consists of two polyols independently selected from those described herein.

Additionally, or alternatively, the one or more polyol selected is a C2 to C12 polyol. Suitably, such a polyol may be linear, branched, cyclic, unsaturated, aromatic, or saturated.

Preferably the C2 to C12 polyol is linear or branched. Preferably the C2 to C12 polyol is saturated. Such polyols provide for a highly chemically stable polyester product. Preferably the one or more polyol may be a C2 to C10 polyol, more preferably a C3 to C8 polyol, and most preferably a C4 to C6 polyol. Such short chain polyols are believed to contribute favourably to the relatively high density of the polyester product formed from the reaction product of a) and b). Particularly suitable polyols may include, for example, propolyene glycol, butanediol (butylene glycol), tri-propylene glycol, di-propolyene glycol, glycerol, trimethylopropane, sorbitol, other sugar alcohols, and alkoxylates thereof. In some embodiments, the one or more polyol selected may be a glycerol. Particularly preferred individual polyols are those listed herein.

Additionally, or alternatively, the one or more polyol may be selected from a glycol, more especially the glycol may be a mono-glycol, a di-glycol, a tri-glycol, or a poly-glycol. Particularly suitable polyols may include linear or branched diols such as ethylene glycol, diethylene glycol, 1,3-propylene glycol, dipropylene glycol, tripropylene glycol, 1,4-butanediol, 1,6-hexylene glycol (also known as hexanediol), neopentyl glycol, 3-methyl pentane glycol, 1,2-propylene glycol and mixtures thereof, and cyclic diols such as 1,4-bis(hydroxymethyl)cyclohexane and 1,4-cyclohexane-dimethanol, poly propylene glycol, and alkoxylates and/or mixtures thereof. Preferably, the glycol may be an ethylene glycol, a propylene glycol, or a butanediol, that is to say that glycols with small carbon chain constituents are preferred. Propylene glycols are particularly preferred, and in accordance with the preferable embodiments described above, di-propylene glycol is an especially preferred polyol. Alternatively, where a poly-glycol is selected as the one or more polyol, the poly-glycol may be a polyalkylene glycol. Suitably, when a poly-glycol is selected it is preferable that the poly-glycol have a weight average molecular weight of up to 400 Mw, and more preferably a weight average molecular weight of up to 300 Mw.

Additionally, the polyester product may comprise an epoxide. In this case the epoxide may be selected as an alternative or in addition to the to the one or more alcohol described above. It is preferable that the epoxide be selected from a mono, di or poly epoxide.

Additionally, the polyester product preferably has a hydroxyl value below 100, more preferably below 70, particularly preferably below 50, and especially preferably below 30 mgKOH/g. Herein, hydroxyl value is defined as the number of mg of potassium hydroxide equivalent to the hydroxyl content of 1 g of sample and was measured by acetylation followed by hydrolysation of excess acetic anhydride. The acetic acid formed was subsequently titrated with an ethanolic potassium hydroxide solution.

Additionally, the polyester product of the present invention preferably has a saponification (SAP) value of between 300 and 410, more preferably between 325 and 400, and most preferably between 350 and 390. Herein, SAP value is defined as the number of milligrams of potassium hydroxide required to saponify completely 1 gram of sample. A known weight of sample is completely saponified with an excess of alcoholic potassium hydroxide. The remaining excess is then determined by titration with a standard acid and from this the SAP value is calculated.

Suitably, the polyester products according to the present invention are biodegradable, and in particular the polyester products are biodegradable in the marine environment.

More especially, the polyester products of the present invention meet the Offshore Chemical Notification Scheme (OCNS) testing requirements for the North Sea (as administered by CEFAS) rendering the materials particularly suitable for use in marine environments.

Preferably the polyester product has a seawater biodegradability of greater than 60% achieved during the 28 day test period. Seawater biodegradability here is measured in accordance with the Organisation for Economic Cooperation and Development standard test OECD 306.

Suitably, the polyester product according to the present invention provide a beneficial ecotoxicity profile, rendering the polyester product particularly suitable for use in aqueous environments. More especially, the polyester products of the present invention provide a positive ecotoxicology profile when tested to internationally recognised methodologies, in particular, the present polyester products provide a positive result when tested in the following standard tests:

OSPAR Commission 2006 Part B. Protocol for a fish acute toxicity test,

ISO 10253 (2016) Water quality—Marine algal growth inhibition test with Skeletonema sp,

ISO 14669 (1999) Water Quality—Determination of acute lethal toxicity to marine copepods (Copepoda; Crustacea), and,

OSPAR Commission (2006) Part A. (A sediment bioassay using an amphipod Corophium sp).

Preferably, the polyester product is not soluble in water.

The present invention also provides a method of making a polyester product having a density of 1 g/cm³, the method comprising reacting said a) one or more C2 to C12 polybasic acid and said b) one or more polyol.

The preferred embodiments of the reactants said a) one or more C2 to C12 polybasic acid and said b) one or more polyol are as described above in relation to the polyester product.

Suitably, the reaction is a direct polymerisation reaction or a transesterification reaction. Preferably the reaction is a transesterification reaction, where condensation between the polybasic acid and polyol provides formation of an ester linkage between the two reactants.

Preferably, the reactants a) and b) are brought into contact within a reaction vessel.

The reactants are preferably agitated, most preferably by mixing. Agitation is preferably employed for the duration of the reaction being performed to ensure complete reaction of the reactants.

Preferably the reactants, once within the reaction vessel, are purged with an inert gas. Suitably the inert gas is nitrogen. The purge acts to remove oxygen from the reaction vessel with may adversely affect the reaction.

Preferably the reaction is catalysed. In this case the reactants a) and b) are brought in to contact with a suitable catalyst to ensure that the polyester product if formed within an economic time frame. The catalyst may be present in the reaction vessel into which the reactants are introduce, or more preferably the catalyst may be introduced to the reaction vessel after the reactants a) and b) have been introduced and (preferably) agitated. Suitable catalysts are known to the skilled person and may be acid or basic in nature and include homogenous or heterogenous type catalysts, for example the catalyst may be selected from the following: p-toluenesulfonic acid, sulfonic acid, hypophosphorous acid, zeolites, Lewis acids, metal salts, basic metal alkoxide, hydroxides and sodium and potassium carbonates. In particular catalysts comprising aluminium, tin or titanium are preferred and TnBT (tetra-n-butyl titanate) is particularly preferred.

Suitably the reaction if performed at a reaction temperature of between 100° C. and 250° C., preferably at a reaction temperature of between 110° C. and 245° C., more preferably between 150° C. to 240° C., even more preferably between 160° C. and 230° C.

Suitably the reaction may be performed under a reduced pressure. In this case, the pressure may be reduced during the purge step, or thereafter. The pressure may be reduced in a step-wise fashion during the reaction being performed up to a maximum pressure reduction. Suitably the reaction may be performed up to a reduced pressure of <1 mbar.

Where the polyester product comprises c) an end cap, this end cap may be introduced to the reactants a) and b) simultaneously or subsequently. Preferably, the c) end cap is present in the reaction vessel prior to heating and/or pressurisation. This allows for ease of processing since no new material is introduced to the reaction vessel post purge or pressurisation of the system. Naturally, such a process favours batch wise manufacturing. Preferred embodiments of the end cap are as described above in relation to the polyester product.

Suitably the reaction is terminated once desirable properties of the polyester product have been achieved. As such, the method comprising the step of intermittently sampling the materials present in the reaction vessel and assessing their physical properties. Once the desirable polyester product has been formed the reaction product will be discharged from the reaction vessel. Preferably, the formed polyester product and the reaction vessel are cooled prior to product discharge, cooling to approximately ambient temperature is preferred for ease of handling of the product. Similarly, where the reaction vessel has been pressurised, the pressure in the reaction vessel is suitably returned to ambient pressure prior to the product being discharged from the reaction vessel.

Once discharged from the reaction vessel, the polyester product may be in a state suitable for use. However, alternatively and additionally, the polyester product may be post processed to enhance the properties of the polyester product initially obtained. As such the present method may include one or more of the following optional steps: treatment with an absorbate, introduction of a filter aid and subsequent filtration, and/or introduction of a bleaching medium. The purpose of these additional optional steps is to enhance the purity of the polyester product by removal of the catalyst (if present), and other impurities, which may be detrimental to the performance or longevity of the polyester product, as well as improving colour and odour of the polyester product if desirable.

Additionally, or alternatively, the present invention provides a composition comprising the polyester product as described above.

In some embodiments, the composition may consist entirely of the polyester product as described above, that is to say that no additional additives or diluents etc. are necessary to render the polyester product suitable for its intended use.

Alternatively, the composition may comprise the polyester product in combination with other materials. Accordingly, the composition may comprise between 0.1 weight % and 99 weight polyester product based on the total composition by weight. Where the composition is to be used in an aquatic environment then the composition preferably comprises at least 70 weight % polyester product so that the benefits of the polyester product are not lost; in particular the combination of high density, low viscosity and toxicology profile are especially important for use in subsea applications, as described further below. Therefore, in some particularly preferred embodiments the composition comprises between 70 and 99 weight % polyester product, more preferably between 75 and 99 weight %. The composition may comprise lower amounts of the polyester products described herein as suitable for other intended uses.

Optionally, the composition may further comprise one or more of the following additional materials: an additional lubricant, a corrosion inhibitor, an anti-wear additive, an extreme pressure additive, an antioxidant, and a biocide.

Suitably each additional material may be present in an amount from between 0.01 weight c)/0 and 20 weight % of the total composition by weight. Particularly preferred amounts of the individual additional materials are discussed more fully below.

Optionally the additional material selected may be one or more additional lubricant. The polyester products of the present invention does provide lubricant properties, but these may be supplemented or modified (for example to provide optimum lubricancy across a wider range of temperatures) by the inclusion of further additional lubricants. The one or more additional lubricant may be selected from any known lubricant, for example, the lubricant may be a polyalphaolefin, ester derived (including di-esters, alternative polyesters, polyol esters, sorbitan esters and phosphate esters), amine derived (including amine phosphates), amide derived, oil-soluble polyalkylene glycols and/or alkyl phosphites. In some embodiments the composition may include two or more additional lubricants, three or more additional lubricants. Preferably the composition comprises no more than four additional lubricants. Where one or more additional lubricants are included in the composition these additional lubricants will be present in a minority (based on % by weight) of the total composition as compared to the polyester product of the present invention.

Optionally the additional material selected may be a corrosion inhibitor. The polyester products of the present invention are not believed to present unacceptable corrosion properties, however, where the composition comprises one or more additional materials (excluding the corrosion inhibitor) the presence of a corrosion inhibitor may be preferred. In this case the amount of corrosion inhibitor present in the composition is between 0.1 weight and 5 weight % based on the total weight of the composition. Suitable corrosion inhibitors may include amidated succinic acid derivatives, sulphonate derivatives, azole derivatives (e.g. imidazoline, thiadiazol, benzotriazole), amines, sarcosines and dibasic acid salts (e.g. dodecanedioic acid amine salt). In some particularly preferred embodiments, the corrosion inhibitor is a yellow metal corrosion inhibitor, and may be, for example, benzotriazole and tolyltriazole, although as will be appreciated by the skilled person such examples are not acceptable for use in environmentally acceptable lubricant fluids.

Optionally the additional material selected may be an anti-wear additive. Preferably the anti-wear additive is present in amount of between 0.1 weight % and 5 weight % based on the total weight of the composition. Preferred anti-wear additives include organic based additives, and in particular organic ashless organic anti-wear additives.

Optionally the additional material selected may be an extreme pressure additive. Preferably the extreme pressure additive is present in amount of between 0.1 weight % and 2 weight c)/0 based on the total weight of the composition. Suitable extreme pressure additives may include sulphur containing esters, sulphur containing olefins, and sulphur containing triglycerides.

Optionally the additional material selected may be an antioxidant. Preferably the antioxidant is present in amount of between 0.05 weight % and 5 weight % based on the total weight of the composition. Suitable antioxidants include primary and secondary antioxidants. Optionally, the antioxidant may be aminic or phenolic in nature, however such antioxidants could only be utilised at very low addition rates where eco-labelling of a formulated product is desirable, as such the antioxidant may preferably be vitamin E.

Optionally, the additional material selected may be a biocide. Preferably the biocide is present in amount of up to 0.1 weight % based on the total weight of the composition. Suitable biocides include formaldehyde and potassium sorbate. Inclusion of a biocide will not be acceptable for use in an environmentally acceptable lubricant fluid where biodegradability of the lubricant is important, as such the inclusion of a biocide is a less preferred feature of the present invention. However, inclusion of a biocide may be preferred for some alternative end uses of the composition.

Preferably the composition is a lubricant. As mentioned above, the present polyester product has desirable biodegradability properties, which would render such a lubricant particularly suitable for use in aqueous environments. As such, said lubricant comprising the polyester product can be considered as an environmentally acceptable lubricant. More especially, the polyester products of the present invention will comply with a wide range of environmental regulations, in particular those set in the United States for The Vessel General Permit (VGP), and those set by the OSPAR Commission. It will be understood that “environmentally acceptable lubricant” (EAL) is a term of art associated with the VGP regulation where it denotes “lubricants that are biodegradable, minimally toxic and are not bio-accumulative”.

Furthermore, the relatively high density of the polyester product of the present invention allows the material to sink if product containment in an aqueous environment is lost. The fact that the material is able to sink means that no sheen is visible on the water surface. In addition, the good biodegradability property of the polyester product ensure that the composition will readily breakdown over time.

Alternatively, the composition is a subsea control fluid, such compositions comprising the polyester product are particularly suitable for use in subsea control applications and use in subsea control devices. Hitherto commercialised subsea control fluids have comprised water-based materials, and although these materials have suitably low viscosity profiles when in use they must be removed and replaced on a regular basis due to short service life, and require complex additive packages to counter corrosion, wear and other problems.

Additionally, or alternatively, the compositions comprising the polyester product are particularly suitable for use in subsea valves.

More preferably the composition is a hydraulic fluid, and most preferably the composition is a sub-sea actuator fluid. Furthermore, the preferred combination of low viscosity and high density properties allow the polyester product to be particularly suitable for use in subsea applications, and in particular, in subsea hydraulic fluid applications where the combination of these two properties allow the product to provide an accurate and fast response over long distances, typically via long lengths of flexible tubing or hose.

Alternatively, the composition may be a flushing fluid. Such a flushing fluid may be useful in the flushing operation of subsea umbilical and/or pipe systems, or for seawater displacement in wellhead and/or Christmas tree systems. Additionally, or alternatively, the high density property of the polyester product provides good hydrostatic properties when in use in subsea systems, this allows compositions comprising the polyester product to be suitable as a hydrostatic pressure stabiliser fluid; use of such a composition in underwater pipes to prevent collapse under pressure is therefore contemplated.

Generally, use of the composition as a hydraulic fluid in a marine environment is provided, and more preferably use as a sub-sea hydraulic fluid, most preferably use as a sub-sea actuator fluid is provided. More especially, a composition comprising the present polyester product is well suited to use in long distance subsea hydraulic actuation systems where the combination of high density and low viscosity properties are particularly preferred to allow fast reaction times during operation of the actuator. Another benefit of compositions comprising the present polyester product is that if a leak occurs in a subsea system (whether an actuator, valve or pipe etc.) where the product is present, the density of the product (enhanced by its lack of solubility in water) prevents the product from leaking out of that system and into the surrounding sea water; instead the polyester product remains largely in-situ within the system. However, even so, the biodegradability and ecotoxicology profile of the product are such that the product would be considered environmentally acceptable if it were to leak out of the system and into the surrounding water. Since maintenance of subsea systems is difficult, and there may be a large time delay between a leak occurring and remedial action being taken, the fact that the polyester product will not have a tendency to leak out of a system is particularly advantageous. It should be appreciated that similar benefits will be advantageous for use in other marine/aqueous environments.

All of the features described herein may be combined with any of the above aspects, in any combination.

### EXAMPLES

The present invention will now be described further by way of example only with reference to the following Examples.

All parts and percentages are given by weight unless otherwise stated.

It will be understood that all tests and physical properties listed have been determined at atmospheric pressure and room temperature (i.e. about 20° C.), unless otherwise stated herein, or unless otherwise stated in the referenced test methods and procedures

### Example 1—Polyester Product of Dimethyl Adipate and Neopentyl Glycol End Capped with Tri(Propylene Glycol) Methyl Ether

At ambient pressure and temperature 216.82 g (1.24 moles) of dimethyl adipate, 77.78 g (0.75 moles) of neopentyl glycol and 205.40 g (1.00 moles) of tri(propylene glycol) methyl ether were charged into a 1 litre five-necked flask reaction vessel fitted with a mechanical stirrer, a thermometer and a nitrogen inlet. 0.1 g of tetra-n-butyl titanate catalyst was subsequently added. The reactants were gradually heated from ambient temperature up to 180° C. and held at this temperature while the reactants and catalyst were agitated via stirring under a nitrogen atmosphere for between 1 and 2 hours. The reactant mixture was then gradually heated up to a reaction temperature of 240° C., over a period of 2 to 4 hours. The temperature of reaction was then held at 240° C. for 2 to 3 hours until a point where little or no further distillate could be seen coming off the reaction. The pressure inside the reaction vessel was then reduced form atmospheric pressure to 200 mbar over a time period of between 4 to 6 hours; this reduction in pressure was used to force the reaction towards completion in a time efficient manner. The elevated temperature and reduced pressure was maintained until the reaction product reached a desired viscosity, before cooling to room temperature and discharging the polyester product thereby formed.

The resulting polyester product was a liquid at room temperature with a kinematic viscosity at 40° C. of 48 mm²/s, and a density at 25° C. of 1.06 g/cm³.

### Example 2—Polyester Product of Dimethyl Adipate and Di(Propyl Glycol) End Capped with Di(Propyl Glycol) Mono Methyl Ether

At ambient pressure and temperature 350.02 g, (2 moles) of dimethyl adipate, 161.75 g (1.2 moles) of di(propyl glycol) and 238.22 g (1.6 moles) of di(propyl glycol) mono methyl ether were charged into a 1 litre five-necked flask reaction vessel fitted with a mechanical stirrer, a thermometer and a nitrogen inlet. A nitrogen purge was performed along with agitation of the reactants via stirring. The reaction vessel temperature was then raised to 180° C. Once the temperature of 180° C. was reached 0.1 g of tetra-n-butyl titanate catalyst was added. The temperature was then increased to the temperature of reaction at 220° C. and this temperature was maintained. The pressure within the reaction vessel was then slowly reduced from atmospheric to 200 mbar to aid completion of the reaction. These conditions were maintained until the reaction product reached a desired viscosity, before cooling to room temperature and discharging the polyester product thereby formed.

The resulting polyester product was a liquid at room temperature with a kinematic viscosity at 40° C. of 55 mm²/s and a density at 20° C. of 1.06 g/cm³. The kinematic viscosity at 4° C. was 431 mm²/s and at 4° C. the product had a density of 1.08 g/cm³.

### Example 3—Polyester Product of Adipic Acid and Di(Propylene Glycol), No End Cap

At ambient pressure and temperature 1169.10 g (8.7 moles) of di(propylene glycol) and 841.33 g (5.8 moles) of adipic acid were charged into a five-necked flask reaction vessel fitted with a mechanical stirrer, a thermometer and a nitrogen inlet. 1.00 g of tetra-n-butyl titanate catalyst was subsequently added. A nitrogen purge was performed along with agitation of the reactants via stirring. The reaction vessel was then heated up to the reaction temperature 220° C. with continued stirring under a nitrogen atmosphere. The progress of the reaction was monitored by measuring the reaction product acid value. The reaction was stopped once the acid value obtained was <0.1 mg KOH/g.

The resulting polyester product was a viscous liquid, with a hydroxyl value of 180 mgKOH/g, saponification value of 361 mgKOH/g and an acid value of 0.09 mgKOH/g. The kinematic viscosity at 40° C. was 270 mm²/s and had a density of 1.09 g/cm³. The kinematic viscosity at 4° C. was 6769 mm²/s and at 4° C. the product had a density of 1.11 g/cm³.

### Example 4—Formulation and Application Testing

The polyester product prepared from Example 2 above was then tested for application as a lubricant; as described above its relatively high density renders it suitable for use in marine, and particularly subsea applications, but given the difficulty of running in situ testing for such applications a simple anti-wear test (described below) was utilised to assess the products utility for such applications where a degree of lubricancy is desirable. In addition, the polyester product was blended with other optional materials to further improve the properties of the polyester product as a lubricant.

The formulations prepared and the anti-wear test results are provided below.

Anti-Wear Test Method

The anti-wear tests were carried out in accordance with ASTM D4172 Standard Test Method for Wear Preventive Characteristics of Lubricating Fluid (Four-Ball Method) (40 kg applied load, speed 1200 rpm, time 1 hour).

The average wear scar diameter (WSD) in millimetres (mm) was recorded and is provided in Table 1 below for each of the formulations including Example 2 polyester product tested.

Additional Materials

Irgalube™ 349 ex. BASF—a mixture of amine phosphates.

Priolube™ 1415 ex. Croda—a mono-ester.

Priolube™ 1973 ex. Croda—an ester.

Span™ 80 ex. Croda—sorbitane mono-oleate.

Span™ 85 ex. Croda—sorbitan trioleate.

Polartech™ MA3408T ex. Italmatch Chemicals—tall oil diethanolamide.

Trilauryl Phosphite.

Ucon™ OSP-46 ex. Dow Performance Lubricants—an oil-soluble polyalkylene glycol (PAG).

Example Formulation Details and WSD Data

TABLE 1
(note that Example 2 polyester product was employed to
provide the total 100 weight % in each formulation).

| Formulation | | | | | | |
|---|---|---|---|---|---|---|
| | Weight | | Weight | | Weight | WSD |
| Material | % | Material | % | Material | % | (mm) |
| (Example 2 | | | | | | 1.080 |
| Polyester | | | | | | |
| Product) | | | | | | |
| Irgalube | 0.5 | | | | | 0.487 |
| 349 | | | | | | |
| Priolube | 1 | | | | | 0.940 |
| 1973 | | | | | | |
| Tall oil | 0.5 | | | | | 0.907 |
| diethanolamide | | | | | | |
| Trilauryl | 2 | | | | | 0.940 |
| Phosphite | | | | | | |
| Priolube | 20 | Irgalube | 0.1 | | | 1.073 |
| 1415 | | 349 | | | | |
| Ucon OSP-46 | 10 | Span 85 | 5 | | | 0.880 |
| Ucon OSP-46 | 20 | Span 85 | 2 | | | 0.900 |
| Ucon OSP-46 | 15 | Span 85 | 1 | | | 0.967 |
| Ucon OSP-46 | 15 | Span 85 | 2 | | | 0.867 |
| Ucon OSP-46 | 10 | Span 85 | 2 | | | 0.880 |
| Ucon OSP-46 | 10 | Span 85 | 2 | Span 80 | 1 | 0.947 |
| Ucon OSP-46 | 10 | Span 85 | 2 | Span 80 | 2 | 0.967 |

The WSD achieved by the polyester product of Example 2 indicates that it provides sufficient lubricancy to be useful in some applications, and in particular as an actuator fluid.

It can be clearly seen from the data above that the inclusion of additional materials at low addition rates allows for provision of a formulation with enhanced lubricancy, which may be desirable for some applications. However, it can also be seen that the addition rates of the additional materials can be increased beyond an optimal addition rate, at which point the WSD improvements are lost. The additional materials exemplified herein were chosen to show that the polyester product of Example 2 has compatibility with a wide range of existing materials which may be incorporated into lubricant formulations for many uses; they are not untended to be limiting upon the scope of the present invention.

1. A polyester product comprising the reaction product of:
a) one or more C2 to C12 polybasic acid, and
b) one or more polyols,
wherein the polyester product has a density of greater than 1 g/cm³ at 25° C.

2. The polyester product of claim 1, having a density of greater than 1.03 g/cm³ at 25° C.

3. The polyester product of claim 2, having a density of greater than 1.05 g/cm³ at 25° C.

4. The polyester product of claim 1, having a density of greater than 1 g/cm³ at 4° C.

5. The polyester product of claim 4, having a density of greater than 1.04 g/cm³ at 4° C.

6. The polyester product of claim 4, having a density of greater than 1.06 g/cm³ at 4° C.

7. The polyester product of claim 1, having a kinematic viscosity at 40° C. of up to 10000 mm²/s.

8. The polyester product of claim 7, having a kinematic viscosity at 40° C. of between 3 and 2500 mm²/s.

9. The polyester product of claim 8, having a kinematic viscosity at 40° C. of between 4 and 1000 mm²/s.

10. The polyester product of claim 1, having a kinematic viscosity at 4° C. of no greater than 100000 mm²/s.

11. The polyester product of claim 10, having a kinematic viscosity at 4° C. of between 200 and 1000 mm²/s.

12. The polyester product of claim 1, further comprising c) an end-cap.

13. The polyester product of claim 12, wherein c) the end cap is selected from one or more of the following: mono-basic acids, mono-alcohols, and epoxides.

14. The polyester product of claim 13, wherein c) the end cap, selected includes a mono-basic acid or a mono-alcohol.

15. The polyester product of claim 14, wherein c) the end cap selected is a mono-alcohol and is a glycol ether.

16. The polyester product of claim 1, wherein the molecular ratio of a):b):c) in the polyester product is in the range 0.1 to 1:0.1 to 1:0 to 1.

17. The polyester product of claim 16, wherein the molecular ratio of a):b):c) in the polyester product is in the range 0.1 to 0.8:0.1 to 0.5:0.1 to 0.2.

18. The polyester product of claim 1, wherein a) the one or more C2 to C12 polybasic acid of the polyester product may be selected from oxalic acid, malonic acid, succinic acid, maleic acid, fumaric acid, malic acid, tartaric acid, glutaric acid, adipic acid, pimelic acid, citric acid, trimellitic acid, suberic acid, 2,5-furandicarboxylic acid, phthalic acid, isophthalic acid, terephthalic acid, butane tetracarboxylic acid, azelaic acid, sebacic acid, dodecanedioic acid, heptane dicarboxylic acid, octenylsuccinic acid, itaconic acid, 2,6 naphthalene dicarboxylic acid, esters thereof, and anhydrides thereof.

19. The polyester product of claim 1, wherein a) the one or more C2 to C12 polybasic acid comprises one or more diacid or triacid.

20. The polyester product of claim 1, wherein a) the one or more C2 to C12 polybasic acid is a C4 to C8 polybasic acid.

21. The polyester product of claim 1, wherein b) the one or more polyols of the polyester product is a diol, triol or hexol.

22. The polyester product of claim 1, wherein b) the one or more polyol of the polyester product is a C2 to C12 polyol.

23. The polyester product of claim 1, wherein b) the one or more polyol of the polyester product is a C2 to C10 polyol.

24. The polyester product of claim 1, wherein b) the one or more polyol of the polyester product is selected from propolyene glycol, butanediol (butylene glycol), tri-propylene glycol, di-propolyene glycol, glycerol, trimethylopropane, sorbitol, other sugar alcohols, and alkoxylates thereof, or a glycerol.

25. The polyester product of claim 1, wherein b) the one or more polyol is a glycol.

26. The polyester product of claim 1, wherein b) the one or more polyol consists of two polyols independently selected.

27. The polyester product of claim 1, having a hydroxyl value below 100 mgKOH/g.

28. The polyester product of claim 1, having a saponification (SAP) value of between 300 and 410.

29. The polyester product of claim 1, wherein the polyester product has a seawater biodegradability of greater than 60%, achieved during the 28 day test period as measured in accordance with the Organisation for Economic Cooperation and Development standard test OECD 306.

30. The polyester product of claim 1, wherein the polyester product provides a positive ecotoxicology profile when tested in one or more of the following standard tests: OSPAR Commission 2006 Part B. Protocol for a fish acute toxicity test, ISO 10253 (2016) Water quality—Marine algal growth inhibition test with Skeletonema sp, ISO 14669 (1999) Water Quality—Determination of acute lethal toxicity to marine copepods (Copepoda; Crustacea), and, OSPAR Commission (2006) Part A. (-A sediment bioassay using an amphipod Corophium sp).

31. The polyester product of claim 1, wherein the polyester product is not soluble in water.

32. A method of making a polyester product as defined in claim 1, the method comprising reacting said a) one or more C2 to C12 polybasic acid and said b) one or more polyol, and optionally c) an end cap.

33. The method of claim 32, wherein the reaction is a transesterification reaction, where condensation between a) the polybasic acid and b) the one or more polyol provides formation of an ester linkage between the two reactants.

34. The method of claim 32, wherein the reaction is catalysed, and the reactants a) and b) are brought in to contact with a suitable catalyst.

35. The method of claim 32, wherein the reaction if performed at a reaction temperature of between 100° C. and 250° C.

36. The method of claim 32, wherein the reaction if performed under a reduced pressure.

37. The method of claim 32, further comprising the step of intermittently sampling the materials present in the reaction vessel and assessing their physical properties.

38. The method of claim 32, further comprising one or more of the following optional steps: treatment with an absorbate, introduction of a filter aid and subsequent filtration, and/or introduction of a bleaching medium.

39. A composition comprising a polyester product as defined in claim 1.

40. The composition of claim 39, comprising between 0.1 weight % and 99 weight % polyester product based on the total composition by weight.

41. The composition of claim 39, wherein the composition comprises at least 70 weight % polyester product based on the total composition by weight.

42. The composition of claim 39, further comprising one or more of the following additional materials: an additional lubricant, a corrosion inhibitor, an anti-wear additive, an extreme pressure additive, an antioxidant, and a biocide.

43. The composition of claim 42, wherein the one or more additional materials are present in an amount from between 0.01 weight % and 20 weight % of the total composition by weight.

44. The composition of claim 39, wherein the composition is a lubricant which can be considered as an environmentally acceptable lubricant.

45. The composition of claim 39, wherein the composition is a subsea control fluid.

46. The composition of claim 39, wherein the composition is a hydraulic fluid, and preferably a sub-sea actuator fluid.

47.-48. (canceled)
